(19) United States
(12) Patent Application Publication
(10) Pub. No.: US 2012/0110826 A1
(43) Pub. Date: May 10, 2012

(54) METHOD AND DEVICE FOR FIXING A FAUCET TO A MOUNTING

(76) Inventors: Hannu Reiman, Jarvenpaa (FI); Raimo Kaukinen, Nastola (FI); Esko Savolainen, Hollola (FI)

(21) Appl. No.: 13/320,359

(22) PCT Filed: May 7, 2010
(86) PCT No.: PCT/FI10/50370

§ 371 Date: Jan. 27, 2012

(30) Foreign Application Priority Data
May 15, 2009 (FI) 20095543

(51) Int. Cl. E03C 1/042; B23P 11/00

(52) U.S. Cl. 29/525.11; 29/525.01; 4/695

(57) ABSTRACT

The invention relates to a method and device for fixing a faucet to a mounting (1), such as a worktop or a sinktop. A fixing collar (2) is fastened to the top surface of a mounting by turning from above one or more set screws (3) extending from the fixing collar (2) over a distance below a bottom surface of the worktop. Turning of the screw is used for raising a clamping claw (4), which is in engagement with the threading of said set screw and which is steered by means of a guide (5) extending downward from the fixing collar and used for disallowing a rotation of the clamping claw (4) along with the set screw (3). The bottom end of a faucet body (10) or its extension is fastened around the fixing collar (2) by expanding the fixing collar (2) by an actuation means, such as a screw (8).

The invention relates to a method and device for fixing a faucet to a mounting, such as a worktop or a sinktop.

Prior known methods and devices necessitate working from under the mounting. Working space is scarce, making it uncomfortable to work with set screws and nuts, as well as a clamping claw. A heavy faucet present above the mounting is difficult to hold steady in a desired position during the fixing process. These are some of the reasons why the prior known fixing methods and devices require an installation time of considerable length.

It is an object of the invention to resolve the foregoing problems and to provide a method and device for fixing a faucet to a mounting, such that the installation work is significantly facilitated and the working time is substantially reduced, even to a fraction of what is required by prior known methods and devices.

This object is achieved in the invention by means of method steps presented in the appended claim 1, as well as by means of a fixing device presented in claim 2. The dependent claims disclose preferred embodiments of the invention.

The invention will now be described more closely with reference to the accompanying drawings, in which

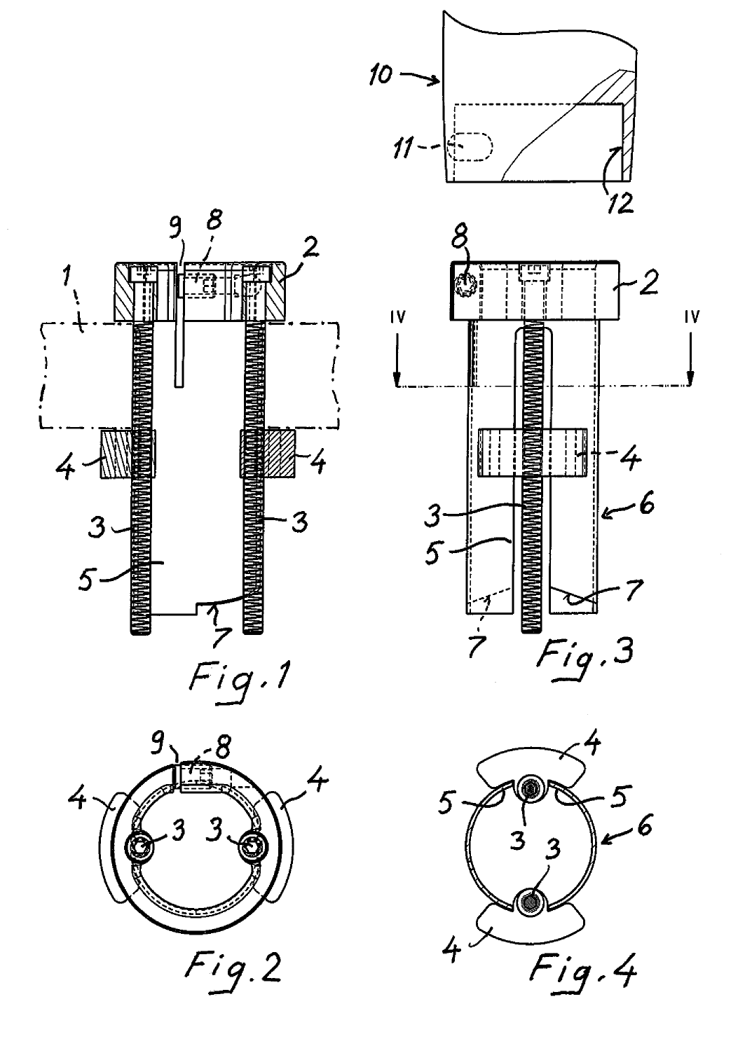

FIG. 1 shows a faucet fixing device of the invention in an immovably mounted position and in a vertical section;

FIG. 2 shows the fixing device of FIG. 1 in a view from above;

FIG. 3 shows the same fixing device in a position rotated by 90° with respect to the position of FIG. 1. A faucet ready for mounting is presented above the fixing device;

FIG. 4 shows a section along a line IV-IV in FIG. 3;

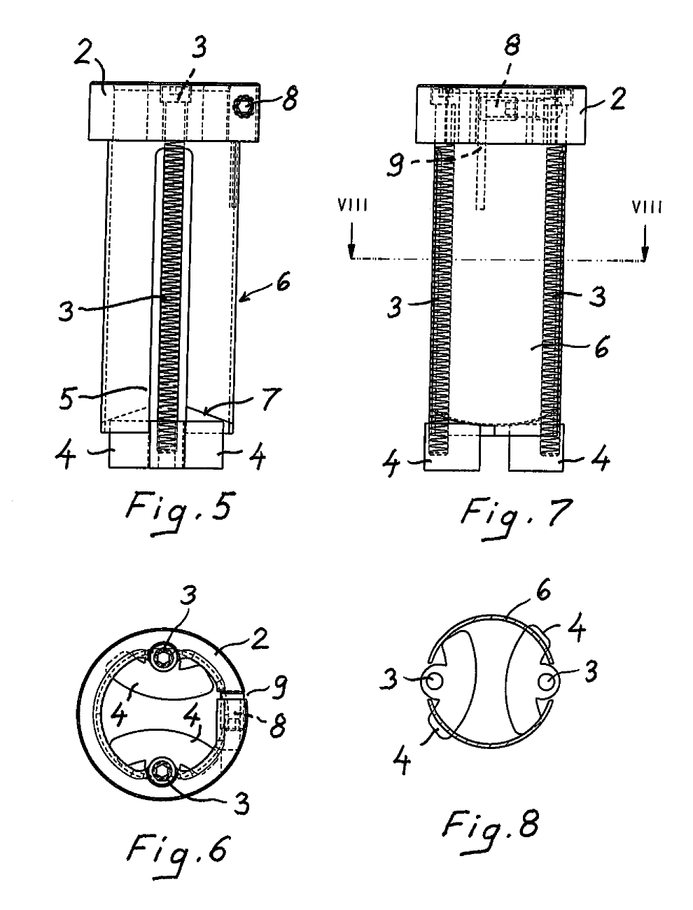

FIG. 5 shows a fixing device in a side view prior to a mounting operation, with clamping claws in a lead-in position;

FIG. 6 shows the fixing device of FIG. 5 in a view from above;

FIG. 7 shows the fixing device of FIG. 5 in a position rotated by 90°; and

FIG. 8 shows a section along a line VIII-VIII in FIG. 7, illustrating the operating range of clamping claws in more detail.

The fixing device includes a fixing collar 2, which is expansible with an actuation means 8 and attachable to a top surface of a mounting 1 by means of mounting elements to be subsequently described in more detail. In the present case, the fixing collar 2 is a split ring and the actuation means comprises a screw 8 capable of enlarging a splitting gap 9 for said expansion. The screw 8 can be replaced by hydraulic oil. Expansion of the fixing collar 2 can also be based on the use of rubber or elastomer, such as silicone.

The fixing collar 2 is cylindrical in its outer surface and has a height which is sufficient for providing a strong compression joint between the expanded fixing collar 2 and the lower end of a faucet body 10 or its extension. The faucet body 10 has its bottom end dimensioned (surface 12) to fit around the fixing collar 2 with a loose sliding fit before the fixing collar 2 is expanded.

The mounting elements for the fixing collar 2 include one or more top-clamping set screws 3, extending from the fixing collar 2 over a distance below a bottom surface of the mounting 1. An essential feature of the invention is the ability to rotate the set screws 3 from above. The set screws 3 have their top ends provided with appropriate engagement formations, such as hex sockets, e.g. for a power-drill operated tool.

The set screw 3 has its thread grabbed by a clamping claw 4, which is raisable by rotating the set screw 3. Alongside the set screw 3 is a guide 5 which disables rotation of the clamping claw 4 along with the set screw, whereby the clamping claw 4 rises to the position shown in FIG. 1 for pinching the mounting, such as a worktop or a sinktop, between the fixing collar 2 and the clamping claw 4. In a preferred case, the fixing device has two set screws 3, which are located on the opposite sides of a central opening of the fixing collar 2 and each of which is provided with its own clamping claw 4. The result is a strong and symmetrically balanced mounting.

In the illustrated case, the guide for the clamping claw 4 comprises a bush 6, which is associated with the fixing collar 2, extends downwards, and is smaller than the fixing collar in its outer diameter, and which is provided with a recess or slot whose edge constitutes the guide 5. Naturally, the guide may consist of any wire or rod located alongside the set screw 3 in a substantially parallel relationship therewith.

In the illustrated preferred embodiment, the guide 5 has a formation 7 at its bottom end, allowing the clamping claw 4 present at the bottom end of the set screw 3 to rotate along with the set screw 3 from a lead-in position shown in FIG. 5, in which the clamping claws 4 are closer to a center axis of the fixing collar 2, to a clamping position shown in FIGS. 1-4, in which the clamping claws 4 are further away from the center axis and in which the clamping claws are held by said guide 5. The clamping claw 4 is an arcuate element, which has a central angle of 60°-120° and which lies essentially in its entirety on one side of the set screw 3, except for an internally threaded bracket engaging the set screw 3. This asymmetric disposition enables movements of the clamping claw 4 between the lead-in and clamping positions.

The faucet body 10 or its extension has its bottom end provided with a slot 11 (FIG. 3), by way of which the actuation means, such as a screw 8, capable of expanding the fixing collar 2, is workable for expanding the fixing collar 2, i.e. increasing its diameter. When using a fixing device of the invention, the mounting is performed in such a way that the fixing device is lead-in the position of FIGS. 5-8 into an installation aperture present in the mounting. This is followed by fastening the fixing collar 2 to a top surface of the mounting by threading from above the set screws 3, the clamping claws 4 turning first against the guides 5, followed by rising upward until colliding with a bottom surface of the mounting. The mounting 1 is retained between the fixing collar 2 and the clamping claws 4. The fixing device may include a direction arrow to indicate a rotated position for clamping the fixing device in order to have the faucet 10, subsequently attached to the fixing collar 2, pointing in the correct direction.

Thereafter, the faucet body 10 has its bottom end, or the faucet body 10 has an extension of its bottom end, placed upon the fixing collar 2, such that the slot 11 coincides with the head of the screw 8, after which, by rotating the screw 8, the fixing collar 2 is expanded to the engagement with a machined gripping surface 12. The surfaces pressing against each other can be cylindrical or, if desired, can be designed with various gripping formations. In tests, however, cylindrical surfaces have been found to achieve the necessary attachment strength many times over.

The term faucet means water faucet or water tap. The places of use of the invented faucets are mainly in kitchen and in bathroom.

1. A method for fixing a faucet to a mounting (1), such as a worktop or a sinktop, said method comprising fastening a fixing collar (2) to a top surface of the mounting by means of fastening elements (3, 4) which are tightened against a bottom surface of the mounting (1) by working the fastening elements from above the mounting, characterized in that the bottom end of a faucet body (10) or its extension is fastened around the fixing collar (2) by expanding the fixing collar (2) by an actuation means.

2. A method as set forth in claim 1, characterized in that the fixing collar (2) is fastened to a top surface of the mounting by turning from above one or more set screws (3) extending from the fixing collar (2) over a distance below a bottom surface of the worktop and said turning is used for raising a clamping claw (4), which is in engagement with the threading of said set screw and which is steered by means of a guide (5) extending downward from the fixing collar and used for disallowing a rotation of the clamping claw (4) along with the set screw (3).

3. A device for fixing a faucet to a mounting (1), such as a worktop or a sinktop, said device including a fixing collar (2), which is attachable to a top surface of the mounting (1) with fastening elements (3, 4) which are tightenable against a bottom surface of the mounting by working the fastening elements from above the mounting, the bottom end of a faucet body (10) or its extension being sized to fit around the fixing collar (2), characterized in that the fixing collar is expansible by an actuation means (8) for providing a sturdy compression joint between the expanded fixing collar (2) and an internal surface of the faucet body or its extension.

4. A device as set forth in claim 3, characterized in that the fastening elements include one or more top-clamping set screws (3) which extend from the fixing collar (2) over a distance below a bottom surface of the mounting (1), a clamping claw (4) in engagement with the threading of the set screw (3) and adapted to be raised by means of rotating the set screw (3), and a guide (5) located alongside the set screw (3) for disallowing rotation of the clamping claw (4) along with the set screw (3).

5. A device as set forth in claim 3 for fixing a faucet to the mounting (1), such as a worktop or a sinktop, characterized in that the fixing collar (2) is a split ring, having its splitting gap (9) adapted to be enlarged by means of a screw (8) for said expansion.

6. A device as set forth in claim 4, for fixing a faucet to the mounting (1), such as a worktop or a sinktop, characterized in that the device has two set screws (3), which are located on the opposite sides of a central opening of the fixing collar (2) and each of which is provided with its own clamping claw (4).

7. A device as set forth in claim 4, for fixing a faucet to the mounting (1), such as a worktop or a sinktop, characterized in that the fixing collar (2) is provided with a downward extending bush (6), which is smaller in outer diameter and which includes a recess or slot whose edge constitutes a guide (5) for the clamping claw (4).

8. A device as set forth in claim 4, for fixing a faucet to the mounting (1), such as a worktop or a sinktop, characterized in that the guide (5) has a formation (7) at its bottom end, allowing the clamping claw (4) present at the bottom end of the set screw (3) to rotate along with the set screw (3) from a lead-in position, in which it is closer to a center axis of the fixing collar (2), to a clamping position, in which it is further away from the center axis and in which the clamping claw is held by said guide (5).

9. A device as set forth in claim 3, for fixing a faucet to the mounting (1), such as a worktop or a sinktop, characterized in that the faucet body (10) or its extension has an aperture (11) in its bottom end, by way of which an actuation means, such as the screw (8), expanding the fixing collar (2), can be set to work for expanding the fixing collar (2).
